(19) United States
(12) Patent Application Publication
(10) Pub. No.: US 2013/0169835 A1
(43) Pub. Date: Jul. 4, 2013

(54) IMAGE CAPTURING DEVICE WITH IMAGE BLENDING FUNCTION AND METHOD THRERFOR

(71) Applicants: Bo ZHANG, Shenzhen City (CN); Pin-Feng FU, Shenzhen City (CN); Jin-Peng ZHANG, Shenzhen City (CN); Tsung-Jen CHUANG, Tu-Cheng (TW)

(72) Inventors: Bo ZHANG, Shenzhen City (CN); Pin-Feng FU, Shenzhen City (CN); Jin-Peng ZHANG, Shenzhen City (CN); Tsung-Jen CHUANG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/469,100

(22) Filed: May 11, 2012

(30) Foreign Application Priority Data
Dec. 30, 2011 (CN) 201110454329.1

(51) Int. Cl. H04N 5/232; H04N 5/228

(52) U.S. Cl. 348/222.1; 348/E05.045

(57) ABSTRACT

An image blending method implemented by an image capturing device includes: focusing on a close foreground and capturing a first image; focusing on a distant background and capturing a second image; and blending the first image and the second image together to generate a composite image, in which the close foreground is from the close background of the first image and is set to an appropriate proportion and the distant background is from the distant background of the second image and is set to an appropriate proportion. The image capturing device is also provided.

### BACKGROUND

1. Technical Field

The present disclosure relates to image capturing technology, and more particularly, to an image capturing device with image blending function and a method for image blending.

2. Description of Related Art

People want to take a perfect image by an easiest way using a camera. However, it is difficult to take an image including a clear foreground while having a clear distant background as they have significantly different object distances and thus can not be both focused in the same image.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of an image capturing device, in accordance with the present disclosure.

FIG. 2 is a flowchart of an embodiment of an image blending method implemented by the image capturing device in FIG. 1, in accordance with the present disclosure.

FIG. 3 is a first schematic diagram of an embodiment of the image capturing device in FIG. 1, in accordance with the present disclosure.

FIG. 4 is a second schematic diagram of an embodiment of the image capturing device in FIG. 1, in accordance with the present disclosure.

FIG. 5 is a third schematic diagram of an embodiment of the image capturing device in FIG. 1, in accordance with the present disclosure.

### DETAILED DESCRIPTION

Embodiments of the present disclosure will be described with reference to the accompanying drawings.

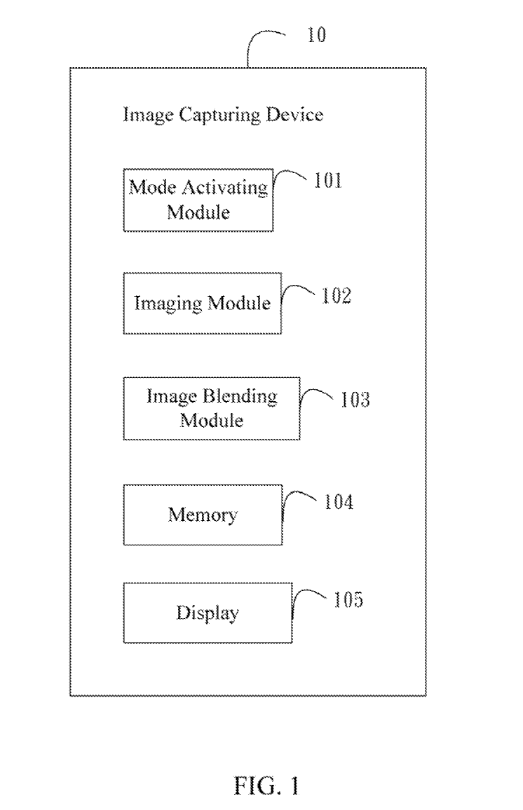

FIG. 1 is a block diagram of an embodiment of an image capturing device, in accordance with the present disclosure. The image capturing device 10 may be a camera. The image capturing device 10 includes a mode activating module 101, an imaging module 102, an image blending module 103, a memory 104, and a display 105.

The mode activating module 101 is used to activate an image blending mode of the image capturing device 10. The mode activating module 101 can be run automatically when the image capturing device 10 is turned on or activated by selections by users. The mode activating module 101 may be activated by a hardware button or virtual button (e.g., an icon on a touch screen).

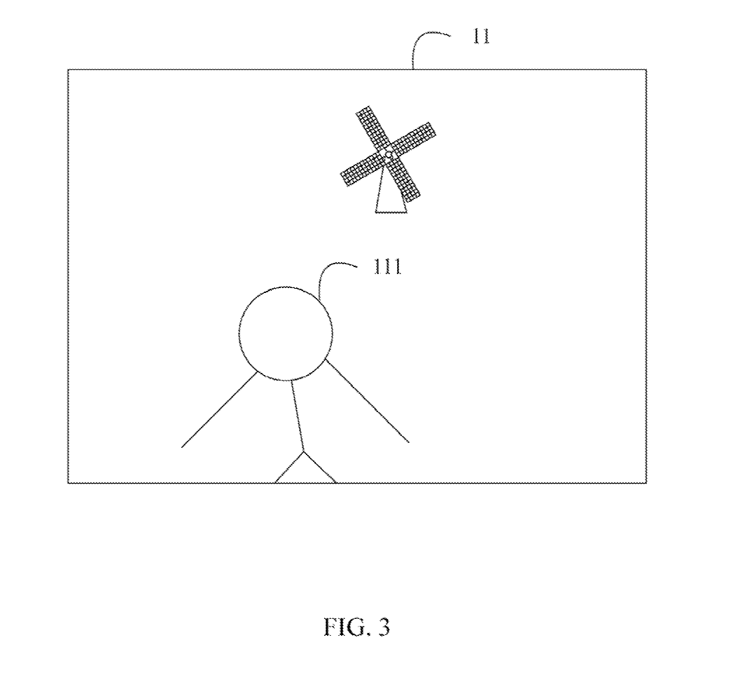

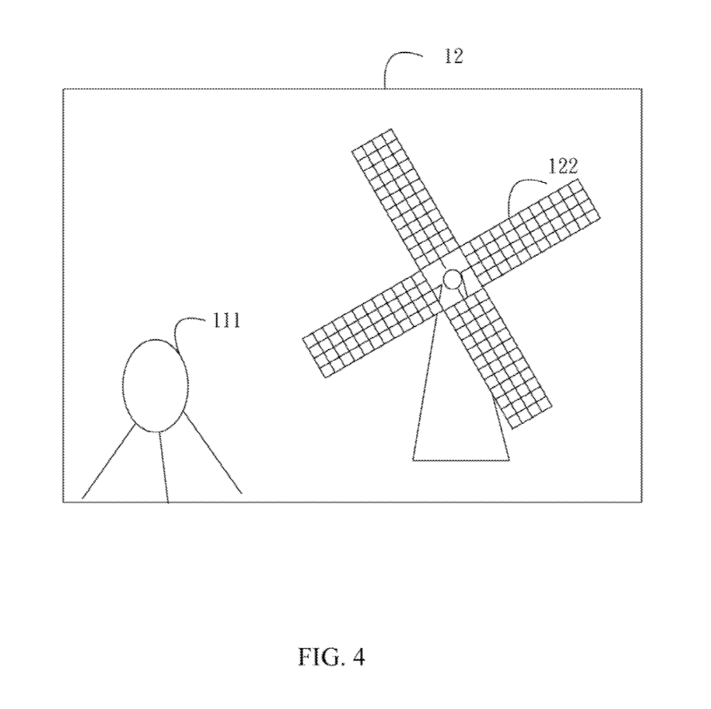

When activating the image blending mode, as shown together with FIGS. 3-4, the imaging module 102 is focused on a close foreground 111 and captures a first image 11, in which the close foreground 111 is clear while a distant background 122 may appear blur, and then the imaging module 102 is focused on the distant background 122 and captures a second image 12, in which the distant background 122 is sharp while the close foreground 111 may loss clearness. In general, in a mode of macro photography, the imaging module 102 can be focused on the close foreground 111 using a short focal length. In a mode of telephoto photography, the imaging module 102 can be focused on the distant background 122 using a long focal length. The user can manually zoom and focus the imaging module 102. In addition, current cameras have various auto-focus functions, accordingly, the imaging module 102 can automatically adjust the focal length and the image plane thereof to focus on an object of interest.

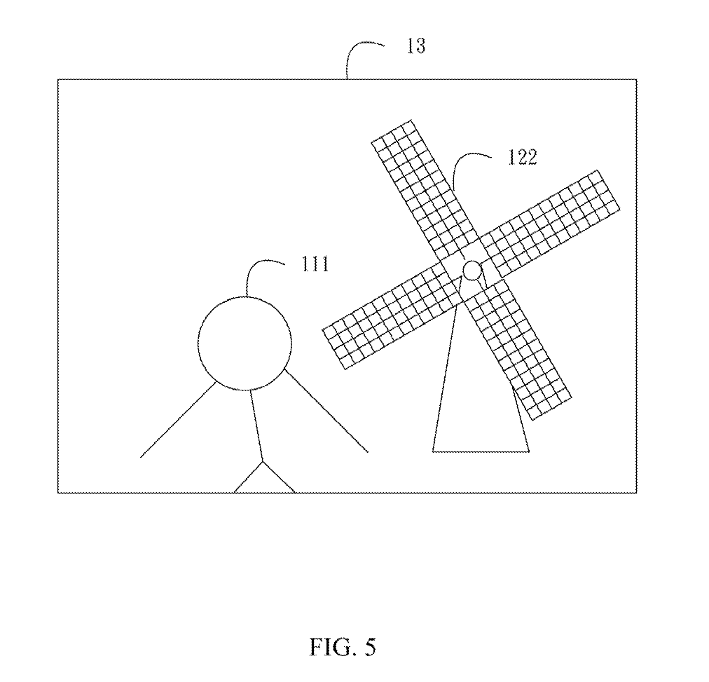

The image blending module 103 is used to compose the first image 11 and the second image 12 together to generate a composite image 13 in which both the close foreground 111 and the distant background 122 are clear and set to at suitable proportions (see FIG. 5) which are decided to be proper for the occasions or some purposes.

In detail, the image blending module 103 identifies the close foreground 111 in the first image 11, cuts the close foreground 111 along a contour thereof from the first image 11, zooming, typically zooming out (i.e., reducing) or, in seldom cases, zooming in (i.e., enlarging), the close foreground 111 according to object distances of the close foreground 111 and the distant background 122, and a size of the distant background 122 in the second image 12, and superimposes the zoomed close foreground 111 on the second image 12 at an appropriate position based upon a position relationship between the close foreground 111 and the distant background 122 to simulate a real scene of the first image 11 and the second image 12, thus yielding the composite image 13. More specifically, the image blending module 103 can use a face recognition technology to identify the close foreground 111 from the first image 11 in case of portrait photography or a mode recognition technology in other occasions.

The memory 104 is configured to store the composite image 13. The display 105 is used to display the composite image 13.

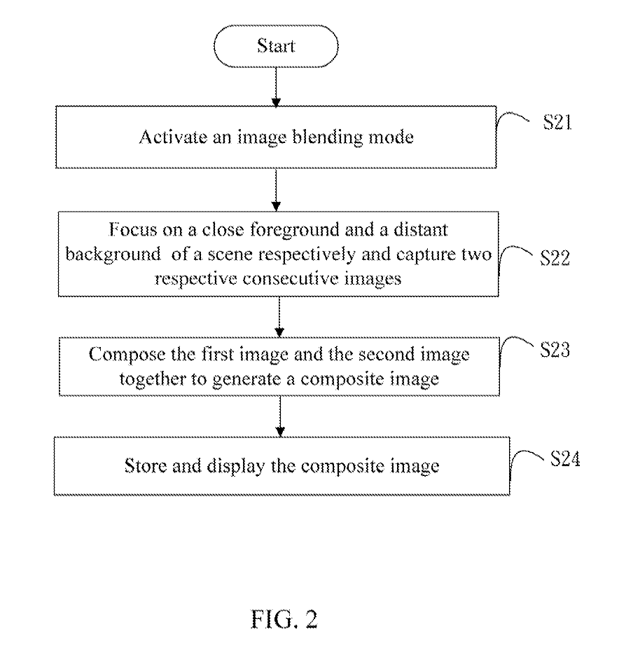

The functions of the modules will be described together with FIG. 2.

FIG. 2 is a flowchart of an embodiment of an image blending method implemented by the image capturing device 10 shown in FIG. 1, in accordance with the present disclosure.

In step S21, the mode activating module 101 activates the image blending mode.

In step S22, the imaging module 102 focuses on the close foreground 111 and captures the first image 11, and then focuses on the distant background 122 and captures the second image 12.

In step S23, the image blending module 103 composes the first image 11 and the second image 12 together to generate the composite image 13.

In step S24, the memory 104 stores the composite image 13 and the display 105 displays the composite image 13.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An image capturing device comprising:
an imaging module, to focus on a close foreground and capture a first image, in which the close foreground is clearly imaged, and then to focus on a distant background and capture a second image, in which the distant background is clearly imaged; and
an image blending module, to compose the first image and the second image together to generate a composite image, in which the close foreground is from the close background of the first image and is set to an appropriate proportion and the distant background is from the distant background of the second image and is set to an appropriate proportion.

2. The image capturing device of claim 1, further comprising:
a mode activating module, to activate an image blending mode of the image capturing device and thus activating the imaging module and the image blending module.

3. The image capturing device of claim 2, wherein the mode activating module is run automatically when the image capturing device is turned on or is activated by selections of a user.

4. The image capturing device of claim 2, wherein the mode activating module is activated by a hardware button or virtual button.

5. The image capturing device of claim 1, wherein the image capturing device further comprises a memory for storing the composite image.

6. The image capturing device of claim 1, wherein the image capturing device further comprises a display to display the composite image.

7. The image capturing device of claim 1, wherein the image capturing device is a camera.

8. The image capturing device of claim 1, wherein the image blending module composes the first image and the second image by identifying the close foreground in the first image, cutting the close foreground along a contour thereof from the first image, zooming the close foreground according to object distances of the close foreground and the distant background, and a size of the distant background in the second image, and superimposing the zoomed close foreground on the second image at an appropriate position based upon a position relationship between the close foreground and the distant background to simulate a real scene of the first image and the second image, thus yielding the composite image.

9. An image blending method implemented by an image capturing device, the method comprising:
focusing on a close foreground and capturing a first image;
focusing on a distant background and capturing a second image; and
blending the first image and the second image together to generate a composite image, in which the close foreground is from the close background of the first image and is set to an appropriate proportion and the distant background is from the distant background of the second image and is set to an appropriate proportion.

10. The image blending method of claim 9, further comprising:
activating an image blending mode of the image capturing device before the steps of focusing.

11. The image blending method of claim 10, wherein the step of activating is automatically implemented when the image capturing device is turned on or manually triggered after selections of a user.

12. The image blending method of claim 10, wherein the step of activating is implemented by a hardware button or virtual button.

13. The image blending method of claim 9, further comprising:
storing the composite image in a memory of the image capturing device.

14. The image blending method of claim 9, further comprising:
displaying the composite image on a display of the image capturing device.

15. The image blending method of claim 9, wherein the image capturing device is a camera.

16. The image blending method of claim 9, wherein the step of blending comprising:
identifying the close foreground in the first image,
cutting the close foreground along a contour thereof from the first image,
zooming the close foreground according to object distances of the close foreground and the distant background, and a size of the distant background in the second image, and
superimposing the zoomed close foreground on the second image at an appropriate position based upon a position relationship between the close foreground and the distant background to simulate a real scene of the first image and the second image, thus yielding the composite image.
